(19) United States
(12) Patent Application Publication
(10) Pub. No.: US 2017/0332412 A1
(43) Pub. Date: Nov. 16, 2017

(54) DATA TRANSMISSION METHOD AND APPARATUS AND COMMUNICATIONS SYSTEM

(71) Applicant: FUJITSU LIMITED, Kawasaki-shi (JP)

(72) Inventors: Xin WANG, Beijing (CN); Sheng LEI, Beijing (CN)

(73) Assignee: FUJITSU LIMITED, Kawasaki-shi (JP)

(21) Appl. No.: 15/665,949

(22) Filed: Aug. 1, 2017

Related U.S. Application Data
(63) Continuation of application No. PCT/CN2015/074705, filed on Mar. 20, 2015.

(51) Int. Cl. H04W 74/08; H04L 27/20

(52) U.S. Cl. CPC H04W 74/0833; H04L 27/20

(57) ABSTRACT

A data transmission method and apparatus and a communications system. The method includes: performing phase rotation on a random access preamble sequence according to data to be transmitted, so as to carry the data to be transmitted in the random access preamble sequence; and transmitting the random access preamble sequence carrying the data to be transmitted via a physical random access channel. Hence, random access and data transmission may be achieved in a transmission step, which is high in transmission efficiency and low in overhead, and a MTC equipment may perform data transmission in a high efficiency manner.

### CROSS REFERENCE TO RELATED APPLICATIONS

This application is a continuation application of International Application PCT/CN2015/074705 filed on Mar. 20, 2015, the entire contents of which are incorporated herein by reference.

### TECHNICAL FIELD

This disclosure relates to the field of communications technologies, and in particular to a data transmission method and apparatus and a communications system.

### BACKGROUND

Two major driving forces of the 5th generation (5G) wireless communication are mobile internet and internet of thing (IoT). Massive devices of 5G system, will 10˜100 times increase on the number of terminal equipment over 4G system. Much terminal equipment is machine type communication (MTC) equipment, which usually needs no sustainable traffic communication, and performs communication intermittently, such as being awoken occasionally and performing communication with a base station for a few data.

And on the other hand, in current 3GPP LTE (long-term evolution) or LTE-advanced (LTE-A) systems, uplink synchronization is performed by a user equipment (UE) by using a random access procedure. FIG. 1 is a schematic diagram of a current random access procedure, in which a contention-based case is shown.

As shown in FIG. 1, the random access procedure includes four steps:

step 1: UE generates a random access preamble, and transmits the random access preamble to a base station via a physical random access channel (PRACH), the random access preamble carrying bit information indicating L2/L3 messages;

step 2: the base station transmits a random access response via a physical downlink shared channel (PDSCH), the random access response including a random access radio network temporary identifier (RA-RNTI), and uplink grants (UL grants) of L2/L3 messages, etc.;

step 3: the UE transmits the L2/L3 messages via a physical uplink shared channel (PUSCH) after receiving the random access response; and

step 4: the base station feeds back a collision solution message to UE succeeding in access.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

However, it was found by the inventors that an amount of data transmitted by MTC equipment is relatively small, and the transmission is often intermittent. And if the MTC equipment still adopts an existing random access procedure, a transmission efficiency is low and overhead is large, which will result in that a data transmission efficiency of the MTC equipment is very low.

Embodiments of this disclosure provide a data transmission method and apparatus and a communications system, in which by jointly modulating data to be transmitted and a random access preamble sequence and transmitting the random access preamble sequence carrying the data to be transmitted via a PRACH, UE is capable of transmitting data in a high-efficiency manner.

According to a first aspect of the embodiments of this disclosure, there is provided a data transmission method, including:

performing phase rotation on a random access preamble sequence according to data to be transmitted, so as to carry the data to be transmitted in the random access preamble sequence; and

transmitting the random access preamble sequence carrying the data to be transmitted via a physical random access channel.

According to a second aspect of the embodiments of this disclosure, there is provided a data transmission apparatus, including:

a carrying unit configured to perform phase rotation on a random access preamble sequence according to data to be transmitted, so as to carry the data to be transmitted in the random access preamble sequence; and

a transmitting unit configured to transmit the random access preamble sequence carrying the data to be transmitted via a physical random access channel.

According to a third aspect of the embodiments of this disclosure, there is provided a communications system, including:

user equipment configured to perform phase rotation on a random access preamble sequence according to data to be transmitted, so as to carry the data to be transmitted in the random access preamble sequence, and transmit the random access preamble sequence carrying the data to be transmitted via a physical random access channel; and

a base station configured to receive the random access preamble sequence carrying the data to be transmitted, and detect the random access preamble sequence to acquire the data to be transmitted.

According to another aspect of the embodiments of this disclosure, there is provided a computer readable program code, which, when executed in UE, will cause a computer unit to carry out the data transmission method as described above in the UE.

According to a further aspect of the embodiments of this disclosure, there is provided a computer readable medium, including a computer readable program code, which will cause a computer unit to carry out the data transmission method as described above in UE.

An advantage of the embodiments of this disclosure exists in that the data to be transmitted are carried by the random access preamble sequence, and the random access preamble sequence carrying the data to be transmitted is transmitted via the PRACH. Hence, by jointly modulating the data to be transmitted and the random access preamble sequence and transmitting the random access preamble sequence carrying the data to be transmitted via a PRACH, UE is capable of transmitting data in a high-efficiency manner.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprise/include” when used in this specification is taken to specify the presence of stated features, integers, steps or components but does not preclude the presence or addition of one or more other features, integers, steps, components or groups thereof.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of this disclosure. To facilitate illustrating and describing some parts of the disclosure, corresponding portions of the drawings may be exaggerated or reduced.

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiment.

FIG. 1 is a schematic diagram of an existing random access procedure;

FIG. 2 is a schematic diagram of the data transmission method of an embodiment of this disclosure;

FIG. 3 is a schematic diagram of the random access preamble sequence of an embodiment of this disclosure;

FIG. 4 is another schematic diagram of the data transmission method of the embodiment of this disclosure;

FIG. 5 is a further schematic diagram of the data transmission method of the embodiment of this disclosure;

FIG. 6 is still another schematic diagram of the data transmission method of the embodiment of this disclosure schematic diagram of;

FIG. 7 is a schematic diagram of a structure of the data transmission apparatus of an embodiment of this disclosure;

FIG. 8 is another schematic diagram of the structure of the data transmission apparatus of the embodiment of this disclosure;

FIG. 9 is a schematic diagram of a structure of the UE of an embodiment of this disclosure; and

FIG. 10 is a schematic diagram of a structure of the communications system of an embodiment of this disclosure.

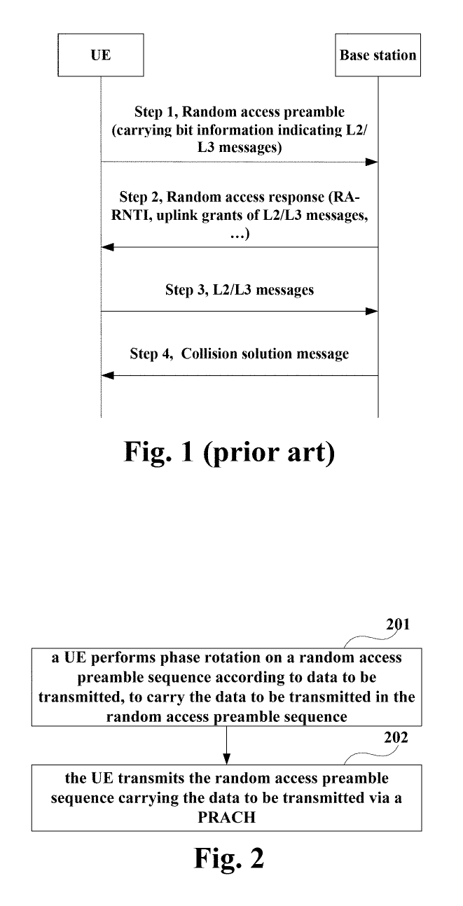

### DETAILED DESCRIPTION

These and further aspects and features of the present disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

### Embodiment 1

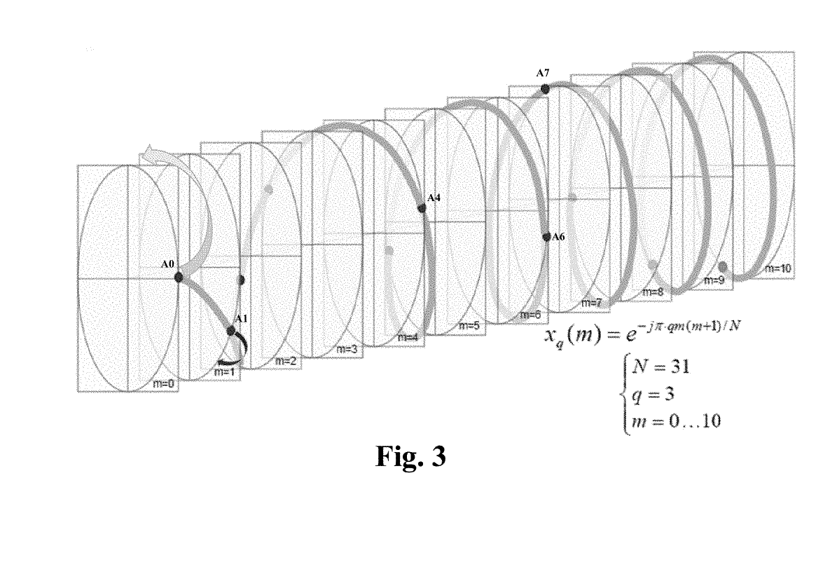

The embodiment of this disclosure provides a data transmission method. FIG. 2 is a schematic diagram of the data transmission method of the embodiment of this disclosure. As shown in FIG. 2, the method includes:

step 201: a user equipment (UE) performs phase rotation on a random access preamble sequence according to data to be transmitted, to carry the data to be transmitted in the random access preamble sequence; and

step 202: the UE transmits the random access preamble sequence carrying the data to be transmitted via a PRACH.

In this embodiment, the data transmission method may be applicable to MTC equipment; however, this disclosure is not limited thereto. For example, a common UE (such as a non-MTC terminal transmitting relatively few data) may also use the data transmission method. Following description shall be given taking a MTC equipment as an example.

In this embodiment, the MTC equipment may communicate with a base station; the base station may be a macro base station, and may also be a pico base station or a femto base station, and may further be a remote radio head (RRH), etc.; however, this disclosure is not limited thereto. Furthermore, a MTC equipment may also perform similar communication with another UE (such as a mobile phone) or another MTC equipment. This disclosure shall be described below only taking that MTC equipment communicates with a base station as an example.

In this embodiment, the performing phase rotation on the random access preamble sequence according to data to be transmitted in step 201 may particularly include: rotating a phase point (which may also be referred to as a constellation point) of the random access preamble sequence by a predetermined angle for each bit of the data to be transmitted according to a value of the bit.

For example, the random access preamble sequence may be generated by performing cyclic shift on a Zadoff-Chu (ZC) sequence. The random access preamble sequence may be expressed by, for example, the following formula:

$${x}_{u} ( n ) = exp [ - j \frac{π un ( n + 1 )}{{N}_{ZC}} ] , 0 \leq n \leq {N}_{ZC} - 1 ;$$

where, u is an index of the ZC sequence, N_{ZC} is a length of the ZC sequence, and xᵤ (n) is the random access preamble sequences; 3GPP 36.211 may be referred to for the ZC sequence or the random access preamble sequences; N_{ZC}=839 is used for preamble formats 0-3, and N_{ZC}=139 is used for preamble format 4.

FIG. 3 is a schematic diagram of the random access preamble sequence of the embodiment of this disclosure, in which an actual example of the sequence is shown. As shown in FIG. 3, the random access preamble sequence may include multiple phase points (which may also be referred to as constellation points) A0, A1, . . . . For each phase point, it may be rotated according to the value of the bit of the data to be transmitted.

For example, for a first bit in data “101101”, as its value is “1”, the phase point A0 may be clockwise rotated by a predetermined angle 1; and for a second bit, as its value is “0”, the phase point A1 may be counterclockwise rotated by a predetermined angle 2. Values of the angle 1 and angle 2 have been agreed between a transmitting device and a receiving device before communication, hence, the receiving device may simultaneously perform blind detection on transmitted random access preamble sequence and data carried by it in an exhaustion manner, and recover transmitted data while capturing the random access preamble sequence.

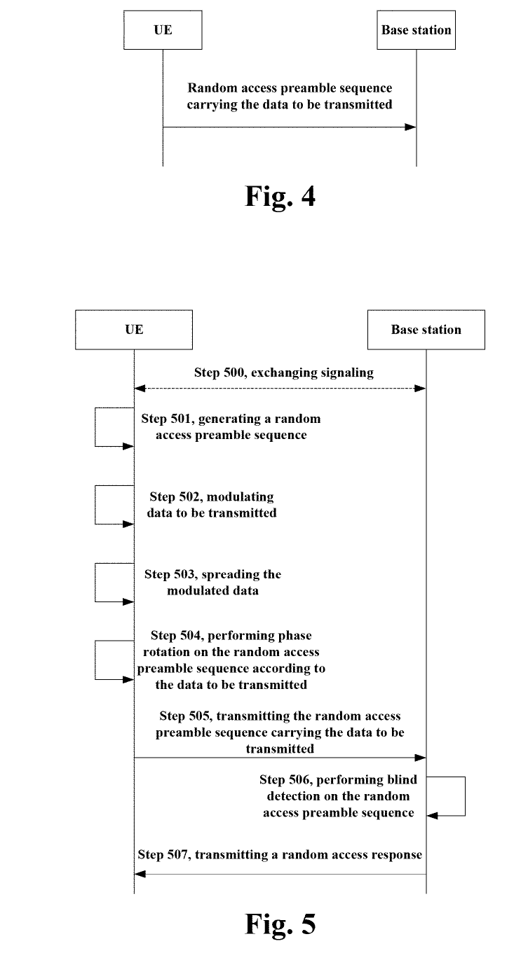

FIG. 4 is another schematic diagram of the data transmission method of the embodiment of this disclosure, in which exchange between the MTC equipment and the base station is shown. For the sake of simplicity, steps of transform at the MTC equipment side and steps of blind detection at the base station side are not shown.

As show in FIG. 4, after carrying the data to be transmitted in the random access preamble sequence, the MTC equipment transmits the random access preamble sequence carrying the data to be transmitted to the base station via the PRACH, and after receiving the random access preamble sequence, the base station may perform blind detection on the random access preamble sequence, so as to obtain the data to be transmitted.

The embodiment of this disclosure shall be described further below by taking that the data to be transmitted are spread as an example.

FIG. 5 is a further schematic diagram of the data transmission method of the embodiment of this disclosure, in which respective processing of the MTC equipment and the base station and exchange therebetween are shown. As show in FIG. 5, the method includes:

step 500: signaling is exchanged between the MTC equipment and the base station;

in this embodiment, information on a code rate and a modulation scheme may be agreed in advance by the MTC equipment and the base station via signaling, and a manner and angle of rotation of the random access preamble sequence by the data may also be agreed in advance. Alternatively, as described later, an agreement may be made according to indices of different random access preamble sequences by dividing the random access preamble sequences into groups, hence, step 500 may be omitted;

step 501: the MTC equipment generates a random access preamble sequence based on a ZC sequence;

step 502: the MTC equipment modulates the data to be transmitted;

as a data transmission rate of the MTC equipment is relatively low, modulation may be performed by using binary phase shift keying (BPSK) or quadrature phase shift keying (QPSK); however, this disclosure is not limited thereto, and other modulation schemes may also be used;

step 503: the MTC equipment spreads the modulated data to be transmitted;

the data to be transmitted may be spread by using an orthogonal or quasi-orthogonal sequence and adopting a formula as below:

dₛₚ((m−1)N_{mc}+k)=d(m)×s_{mc}(k),1≦k≦N_{mc},1≦m≦N_{ZC}/N_{mc};

where, N_{ZC} is a length of the ZC sequence, s_{mc}(k) is a spreading sequence group consisting of ±1, which may be a Hadamard coding set or a set of m sequences, SF-ID is an index of the spreading sequence, 0≦SF-ID≦64, the sequence group here being assumed as having 64 sequences at most, however, this disclosure is not limited thereto, and more sequences may be used; N_{mc} is a length of the spreading sequence, which may determined by a demand for a reception performance of an MTC message and a reliability of detection of PRACH collision; d(m) is the data to be transmitted, and dₛₚ (·) is the spread data to be transmitted;

in this embodiment, the length of the spreading sequence is mainly dependent on the number of UE at collision of random access preambles and a requirement on a detection performance; hence, a probability of collision of the random access preambles may be lowered by increasing a spreading length, and precision of the preamble detection and accuracy of the data recovery may be improved;

step 504: the MTC equipment performs phase rotation on the random access preamble sequence according to the data to be transmitted;

in an implementation, in a case where a modulation mode of d(m) is QPSK,

Cxᵤ(2n)=Sign(Re(dₛₚ(n)))·Δ·xᵤ(2n),

Cxᵤ(2n+1)=Sign(Im(dₛₚ(n)))·Δ·xᵤ(2n+1);

and in a case where a modulation mode of d(m) is BPSK,

Cxᵤ(n)=Sign(dₛₚ(n))·Δ·xᵤ(2n);

where, xᵤ (n) is the random access preamble sequence, u is an index of the ZC sequence, Δ=e^{jδ}, 0<δ≦π/4, Sign( ) denotes taking a sign function, Re( ) denotes a real part of a complex number, and Im( ) denotes an imaginary part of the complex number; and Cxᵤ (·) is the random access preamble sequence carrying the data to be transmitted;

in this implementation, the phase points of the random access preamble sequence may be rotated by a relatively small angle (i.e. relatively few disturbances are introduced); and as major shape information on original preamble sequence is reserved, complexity of blind detection by the receiving device is low, but performance of anti-noise is lowered; in order to improve the performance of detection, the length of the above spreading sequence may be increased; of course, this will bring about lowering of the data transmission efficiency;

in another implementation, in a case where a modulation mode of d(m) is QPSK,

Cxᵤ(2n)=Sign(Re(dₛₚ(n)))·xᵤ(2n);

Cxᵤ(2n+1)=Sign(Im(dₛₚ(n)))·xᵤ(2n+1);

and in a case where a modulation mode of d(m) is BPSK,

Cxᵤ(n)=Sign(dₛₚ(n))·xᵤ(2n);

where, Sign( ) denotes taking a sign function, Re( ) denotes a real part of a complex number, Im( ) denotes an imaginary part of the complex number, and Cxᵤ(n) is the random access preamble sequence carrying the data to be transmitted;

in this implementation, the phase points of the random access preamble sequence may be rotated by a relatively large angle (i.e. a constellation angle of QPSK or BPSK); hence, the performance of anti-noise of the detection is relatively high, but the complexity of blind detection by the receiving device may be also high;

it should be noted that examples of how to perform phase rotation are only illustrated above. However, this disclosure is not limited thereto; for example, phase rotation may also be performed on the random access preamble sequence in other manners, so as to carry the data to be transmitted in the random access preamble sequence;

step 505: the MTC equipment transmits the random access preamble sequence carrying the data to be transmitted via the PRACH;

the signals may be transmitted to the base station after various processing, such as modulation;

step 506: the base station performs blind detection on the random access preamble sequence carrying the data to be transmitted after receiving the random access preamble sequence, to obtain the data to be transmitted;

the base station may also perform such processing on the data to be transmitted as demodulation, etc.;

step 507: the base station transmits a random access response to the MTC equipment.

In this embodiment, the signal transmitted via the PRACH at least carries the following information: index of the random access preamble sequence (Preamble Index), an RA-RNTI, a serial number of the spreading sequence (SF-ID), and the data to be transmitted. And the random access response may at least include the following detected information: the index of the random access preamble sequence (Preamble Index), the RA-RNTI, and ACK/NACK, and may also include the SF-ID.

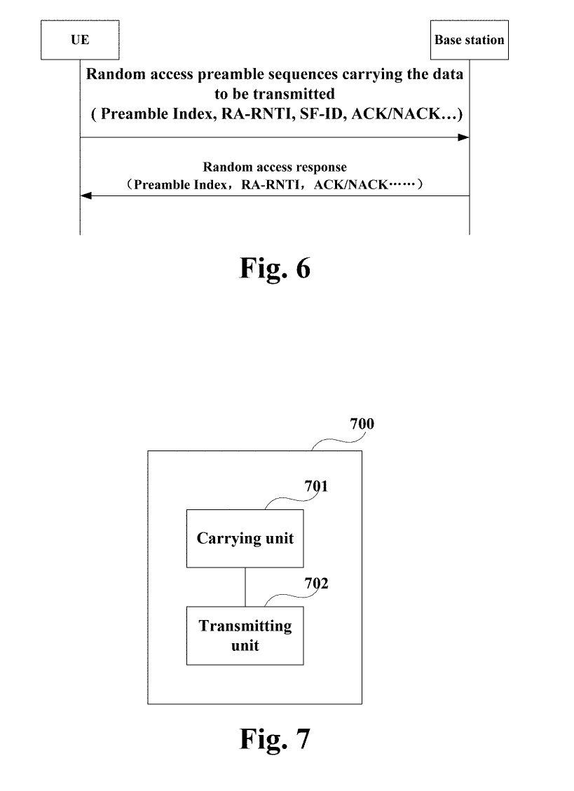

FIG. 6 is still another schematic diagram of the data transmission method of the embodiment of this disclosure, in which exchange between the MTC equipment and the base station is shown. For the sake of simplicity, steps of transform at the MTC equipment side and steps of blind detection at the base station side are not shown.

As show in FIG. 6, after carrying the data to be transmitted in the random access preamble sequence, the MTC equipment may transmit a signal to the base station via the PRACH; the signal carries the preamble index, the RA-RNTI, SF-ID and the data to be transmitted. The random access response includes the detected preamble index, the RA-RNTI, and the ACK/NACK; and whether the data are accurately transmitted is fed back by the random access response, and useless retransmission may be avoided. Thus, the base station needs not to transmit a collision solution message any longer.

It should be noted that this disclosure is not limited to the information shown in FIG. 6. For example, one or more pieces of the information may be omitted, or other information may be added, as actually demanded. And those skilled in the art may determine particular information carried in the random access preamble or the random access response according to an actual situation.

FIG. 5 shows determination of the information on a code rate and a modulation scheme of both the receiving device and the transmitting device by using signaling exchange; however, this disclosure is not limited thereto. Random access preamble sequences may be pre-divided into multiple groups, indices of different groups of random access preamble sequences corresponding to different code rates and modulation schemes. Accordingly, the base station may simultaneously obtain the information on a code rate and a modulation scheme according to the preamble index after receiving the random access preamble sequence, hence, no extra signaling is needed to exchange the information, thereby saving resource overhead and improving flexibility of the scheme.

It can be seen from the above embodiment that the data to be transmitted are carried by the random access preamble sequence, and the random access preamble sequence carrying the data to be transmitted is transmitted via the PRACH. Hence, by jointly modulating the data to be transmitted and the random access preamble sequence and transmitting the random access preamble sequence carrying the data to be transmitted via a PRACH, UE is capable of transmitting data in a high-efficiency manner.

### Embodiment 2

The embodiment of this disclosure provides a data transmission apparatus. This embodiment corresponds to the data transmission method of Embodiment 1, with identical contents being not going to be described herein any further.

FIG. 7 is a schematic diagram of a structure of the data transmission apparatus of an embodiment of this disclosure. As shown in FIG. 7, the data transmission apparatus 700 includes:

a carrying unit 701 configured to perform phase rotation on a random access preamble sequence according to data to be transmitted, so as to carry the data to be transmitted in the random access preamble sequence; and

a transmitting unit 702 configured to transmit the random access preamble sequence carrying the data to be transmitted via a PRACH.

In this embodiment, the carrying unit 701 may be configured to rotate a phase point of the random access preamble sequence by a predetermined angle for each bit of the data to be transmitted according to a value of the bit.

FIG. 8 is another schematic diagram of the structure of the data transmission apparatus of the embodiment of this disclosure. As shown in FIG. 8, the data transmission apparatus 800 includes: a carrying unit 701 and a transmitting unit 702, as described above.

As shown in FIG. 8, the data transmission apparatus 800 may further include:

a preamble generating unit 801 configured to generate the random access preamble sequence based on a ZC sequence;

a modulating unit 802 configured to modulate the data to be transmitted; and

a spreading unit 803 configured to spread the modulated data to be transmitted.

For example, the random access preamble sequence may be expressed by the following formula:

$${x}_{u} ( n ) = exp [ - j \frac{π un ( n + 1 )}{{N}_{ZC}} ] , 0 \leq n \leq {N}_{ZC} - 1 ;$$

and the data to be transmitted may be spread by using the following formula:

dₛₚ((m−1)N_{mc}+k)=d(m)×s_{mc}(k),1≦k≦N_{mc},1≦m≦N_{ZC}/N_{mc};

where, u is an index of the ZC sequence, N_{ZC} is a length of the ZC sequence, s_{mc}(k) is a spreading sequence consisting of ±1, N_{mc} is a length of the spreading sequence, d(m) is the data to be transmitted, xᵤ (n) is the random access preamble sequence, and dₛₚ(·) is the spread data to be transmitted.

In an implementation, the carrying unit 701 may be configured as:

in a case where a modulation mode of d(m) is QPSK,

Cxᵤ(2n)=Sign(Re(dₛₚ(n)))·Δ·xᵤ(2n);

Cxᵤ(2n+1)=Sign(Im(dₛₚ(n)))·Δ·xᵤ(2n+1);

and in a case where a modulation mode of d(m) is BPSK,

Cxᵤ(n)=Sign(dₛₚ(n))·Δ·xᵤ(2n);

where, xᵤ(n) is the random access preamble sequence, u is an index of the ZC sequence, Δ=e_{jδ}, 0<δ≦π/4 Sign( ) denotes taking a sign function, Re( ) denotes a real part of a complex number, and Im( ) denotes an imaginary part of the complex number; and Cxᵤ(·) is the random access preamble sequence carrying the data to be transmitted.

In another implementation, the carrying unit 701 may be configured as:

in a case where a modulation mode of d(m) is QPSK,

Cxᵤ(2n)=Sign(Re(dₛₚ(n)))·xᵤ(2n),

Cxᵤ(2n+1)=Sign(Im(dₛₚ(n)))·xᵤ(2n+1);

and in a case where a modulation mode of d(m) is BPSK,

Cxᵤ(n)=Sign(dₛₚ(n))·xᵤ(2n);

where, Sign( ) denotes taking a sign function, Re( ) denotes a real part of a complex number, Im( ) denotes an imaginary part of the complex number, and Cxᵤ(n) is the random access preamble sequence carrying the data to be transmitted.

In this embodiment, a signal transmitted in the PRACH may at least carry the following information: index of the random access preamble sequence, a random access wireless network temporary identifier, a serial number of the spreading sequence, and the data to be transmitted.

As shown in FIG. 8, the data transmission apparatus 800 may further include:

a receiving unit 804 configured to receive a random access response, the random access response least including the following information: the index of the random access preamble sequence, the random access wireless network temporary identifier, and acknowledgment information.

In this embodiment, the data transmission apparatus 700 or 800 may be configured in MTC equipment; however, this disclosure is not limited thereto. For example, the data transmission apparatus 700 or 800 may be configured in common UE (such as a non-MTC terminal transmitting relatively few data).

In this embodiment, the UE may receive signaling containing information on a code rate and a modulation scheme, that is, the information on a code rate and a modulation scheme may be agreed in advance by the UE and the base station via signaling. Or, the random access preamble sequences are pre-divided into multiple groups, indices of different groups of random access preamble sequences corresponding to different code rates and modulation schemes. Furthermore, a manner and angle of rotation of the random access preamble sequence by the data may also be agreed by the UE and the base station in advance.

The embodiment of this disclosure further provides UE, configured with the data transmission apparatus 700 or 800 described above.

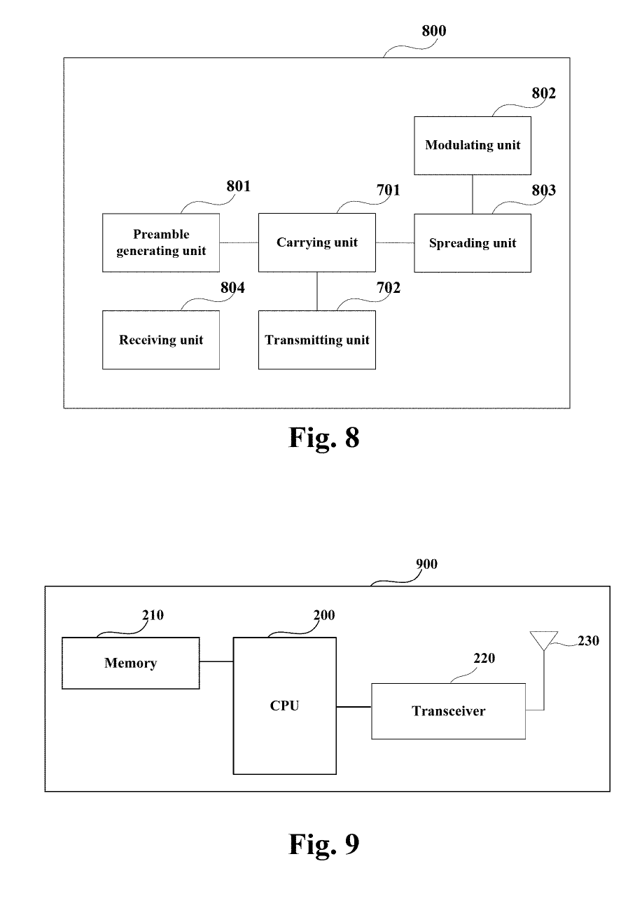

FIG. 9 is a schematic diagram of a structure of the UE of the embodiment of this disclosure. As shown in FIG. 9, the UE 900 may include a central processing unit (CPU) 200 and a memory 210, the memory 210 being coupled to the central processing unit 200. The memory 210 may store various data, and furthermore, it may store a program for information processing, and execute the program under control of the central processing unit 200.

For example, the UE 900 may carry out the data transmission method described in Embodiment 1. And the central processing unit 200 may be configured to carry out the functions of the data transmission apparatus 700 or 800, that is, the central processing unit 200 may be configured to perform the following control: performing phase rotation on a random access preamble sequence according to data to be transmitted, so as to carry the data to be transmitted in the random access preamble sequence; and transmitting the random access preamble sequence carrying the data to be transmitted via a physical random access channel.

Furthermore, as shown in FIG. 9, the UE 900 may include a transceiver 220, and an antenna 230, etc. Functions of the above components are similar to those in the relevant art, and shall not be described herein any further. It should be noted that the UE 900 does not necessarily include all the parts shown in FIG. 9, and furthermore, the UE 900 may include parts not shown in FIG. 9, and the relevant art may be referred to.

It can be seen from the above embodiment that the data to be transmitted are carried by the random access preamble sequence, and the random access preamble sequence carrying the data to be transmitted is transmitted via the PRACH. Hence, by jointly modulating the data to be transmitted and the random access preamble sequence and transmitting the random access preamble sequence carrying the data to be transmitted via a PRACH, UE is capable of transmitting data in a high-efficiency manner.

### Embodiment 3

The embodiment of this disclosure provides a communications system, with contents identical to those in embodiments 1 and 2 being not going to be described herein any further.

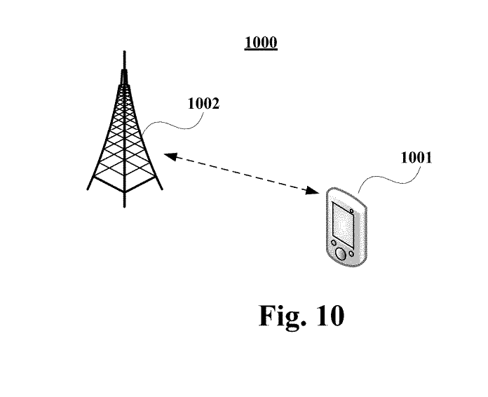

FIG. 10 is a schematic diagram of a structure of the communications system of an embodiment of this disclosure. As shown in FIG. 10, the communications system includes: UE 1001 and a base station 1002.

The UE 1001 is configured to perform phase rotation on a random access preamble sequence according to data to be transmitted, so as to carry the data to be transmitted in the random access preamble sequence, and transmit the random access preamble sequence carrying the data to be transmitted via a physical random access channel.

And the base station 1002 is configured to receive the random access preamble sequence carrying the data to be transmitted, and detect the random access preamble sequence to acquire the data to be transmitted.

In this embodiment, the UE 1001 may be MTC equipment. However, this disclosure is not limited thereto, and the UE 1001 may also be common UE (such as a non-MTC terminal transmitting relatively few data). And the base station 1002 may be a macro base station, and may also be a pico base station or a femto base station, and may further be a remote radio head, etc.; however, this disclosure is not limited thereto.

An embodiment of the present disclosure provides a computer readable program code, which, when executed in UE, will cause a computer unit to carry out the data transmission method described in Embodiment 1 in the UE.

An embodiment of the present disclosure provides a computer readable medium, including a computer readable program code, which will cause a computer unit to carry out the data transmission method described in Embodiment 1 in UE.

The above apparatuses and methods of the present disclosure may be implemented by hardware, or by hardware in combination with software. The present disclosure relates to such a computer-readable program that when the program is executed by a logic device, the logic device is enabled to carry out the apparatus or components as described above, or to carry out the methods or steps as described above. The present disclosure also relates to a storage medium for storing the above program, such as a hard disk, a floppy disk, a CD, a DVD, and a flash memory, etc.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams shown in the drawings may also be realized as a combination of computing equipment, such as a combination of a DSP and a microprocessor, multiple processors, one or more microprocessors in communication combination with a DSP, or any other such configuration.

The present disclosure is described above with reference to particular embodiments. However, it should be understood by those skilled in the art that such a description is illustrative only, and not intended to limit the protection scope of the present disclosure. Various variants and modifications may be made by those skilled in the art according to the principle of the present disclosure, and such variants and modifications fall within the scope of the present disclosure.

What is claimed is:

1. A data transmission method, comprising:
performing phase rotation on a random access preamble sequence according to data to be transmitted, so as to carry the data to be transmitted in the random access preamble sequence; and
transmitting the random access preamble sequence carrying the data to be transmitted via a physical random access channel.

2. The data transmission method according to claim 1, wherein the performing phase rotation on a random access preamble sequence according to data to be transmitted comprises:
rotating a phase point of the random access preamble sequence by a predetermined angle for each bit of the data to be transmitted according to a value of the bit.

3. The data transmission method according to claim 1, wherein before performing phase rotation on a random access preamble sequence according to data to be transmitted, the method further comprises:
generating the random access preamble sequence based on a ZC sequence;
modulating the data to be transmitted; and
spreading the modulated data to be transmitted.

4. The data transmission method according to claim 3, wherein,
the random access preamble sequence is expressed by the following formula:
$${x}_{u} ( n ) = exp [ - j \frac{π un ( n + 1 )}{{N}_{ZC}} ] , 0 \leq n \leq {N}_{ZC} - 1 ;$$
and the data to be transmitted are spread by using the following formula:
dₛₚ((m−1)N_{mc}+k)=d(m)×s_{mc}(k),1≦k≦N_{mc},1≦m≦N_{ZC}/N_{mc};
where, u is an index of the ZC sequence, N_{ZC} is a length of the ZC sequence, s_{mc}(k) is a spreading sequence consisting of ±1, N_{mc} is a length of the spreading sequence, d(m) is the data to be transmitted, xᵤ(n) is the random access preamble sequence, and dₛₚ(·) is the spread data to be transmitted.

5. The data transmission method according to claim 4, wherein performing phase rotation on a random access preamble sequence according to data to be transmitted comprises:
in a case where a modulation mode of d(m) is quadrature phase shift keying (QPSK),
Cxᵤ(2n)=Sign(Re(dₛₚ(n)))·Δ·xᵤ(2n),
Cxᵤ(2n+1)=Sign(Im(dₛₚ(n)))·Δ·xᵤ(2n+1);
and in a case where a modulation mode of d(m) is binary phase shift keying (BPSK),
Cxᵤ(n)=Sign(dₛₚ(n))·Δ·xᵤ(2n);
where, Δ=e^{jδ}, 0<δ≦π/4, Sign( ) denotes taking a sign function, Re( ) denotes a real part of a complex number, Im( ) denotes an imaginary part of the complex number, and Cxᵤ (·) is the random access preamble sequence carrying the data to be transmitted.

6. The data transmission method according to claim 4, wherein the performing phase rotation on a random access preamble sequence according to data to be transmitted comprises:
in a case where a modulation mode of d(m) is QPSK,
Cxᵤ(2n)=Sign(Re(dₛₚ(n)))·xᵤ(2n),
Cxᵤ(2n+1)=Sign(Im(dₛₚ(n)))·xᵤ(2n+1);
and in a case where a modulation mode of d(m) is BPSK,
Cxᵤ(n)=Sign(dₛₚ(n))·xᵤ(2n);
where, Sign( ) denotes taking a sign function, Re( ) denotes a real part of a complex number, Im( ) denotes an imaginary part of the complex number, and Cxᵤ(n) is the random access preamble sequence carrying the data to be transmitted.

7. The data transmission method according to claim 4, wherein a signal transmitted in the physical random access channel at least carries the following information: index of the random access preamble sequence, a random access wireless network temporary identifier, a serial number of the spreading sequence, and the data to be transmitted.

8. The data transmission method according to claim 7, wherein the method further comprises:
receiving a random access response, the random access response at least comprising the following information: the index of the random access preamble sequence, the random access wireless network temporary identifier, and acknowledgment information.

9. The data transmission method according to claim 1, wherein the method further comprises:
receiving signaling containing information on a code rate and a modulation scheme; or
pre-dividing random access preamble sequences into multiple groups, indices of different groups of random access preamble sequences corresponding to different code rates and modulation schemes.

10. A data transmission apparatus, comprising:
a carrying unit configured to perform phase rotation on a random access preamble sequence according to data to be transmitted, so as to carry the data to be transmitted in the random access preamble sequence; and
a transmitting unit configured to transmit the random access preamble sequence carrying the data to be transmitted via a physical random access channel.

11. The data transmission apparatus according to claim 10, wherein the carrying unit is configured to rotate a phase point of the random access preamble sequence by a predetermined angle for each bit of the data to be transmitted according to a value of the bit.

12. The data transmission apparatus according to claim 10, wherein the apparatus further comprises:
a preamble generating unit configured to generate the random access preamble sequence based on a ZC sequence;
a modulating unit configured to modulate the data to be transmitted; and
a spreading unit configured to spread the modulated data to be transmitted.

13. The data transmission apparatus according to claim 12, wherein,
the random access preamble sequence is expressed by the following formula:
$${x}_{u} ( n ) = exp [ - j \frac{π un ( n + 1 )}{{N}_{ZC}} ] , 0 \leq n \leq {N}_{ZC} - 1 ;$$
and the data to be transmitted are spread by using the following formula:
dₛₚ((m−1)N_{mc}+k)=d(m)×s_{mc}(k),1≦k≦N_{mc},1≦m≦N_{ZC}/N_{mc};
where, u is an index of the ZC sequence, N_{ZC} is a length of the ZC sequence, s_{mc}(k) is a spreading sequence consisting of ±1, N_{mc} is a length of the spreading sequence, d(m) is the data to be transmitted, xᵤ(n) is the random access preamble sequence, and dₛₚ(·) is the spread data to be transmitted.

14. The data transmission apparatus according to claim 13, wherein the carrying unit is configured as:
in a case where a modulation mode of d(m) is QPSK,
Cxᵤ(2n)=Sign(Re(dₛₚ(n)))·Δ·xᵤ(2n),
Cxᵤ(2n+1)=Sign(Im(dₛₚ(n)))·Δ·xᵤ(2n+1);
and in a case where a modulation mode of d(m) is BPSK,
Cxᵤ(n)=Sign(dₛₚ(n))·Δ·xᵤ(2n);
where, Δ=e^{jδ}, 0<δ≦π/4, Sign( ) denotes taking a sign function, Re( ) denotes a real part of a complex number, Im( ) denotes an imaginary part of the complex number, and Cxᵤ (·) is the random access preamble sequence carrying the data to be transmitted.

15. The data transmission apparatus according to claim 13, wherein the carrying unit is configured as:
in a case where a modulation mode of d(m) is QPSK,
Cxᵤ(2n)=Sign(Re(dₛₚ(n)))·xᵤ(2n),
Cxᵤ(2n+1)=Sign(Im(dₛₚ(n)))·xᵤ(2n+1);
and in a case where a modulation mode of d(m) is BPSK,
Cxᵤ(n)=Sign(dₛₚ(n))·xᵤ(2n);
where, Sign( ) denotes taking a sign function, Re( ) denotes a real part of a complex number, Im( ) denotes an imaginary part of the complex number, and Cxᵤ(n) is the random access preamble sequence carrying the data to be transmitted.

16. The data transmission apparatus according to claim 13, wherein a signal transmitted in the physical random access channel at least carries the following information: index of the random access preamble sequence, a random access wireless network temporary identifier, a serial number of the spreading sequence, and the data to be transmitted.

17. The data transmission apparatus according to claim 16, wherein the data transmission apparatus further comprises:
a receiving unit configured to receive a random access response, the random access response least comprising the following information: the index of the random access preamble sequence, the random access wireless network temporary identifier, and acknowledgment information.

18. The data transmission apparatus according to claim 10, wherein the data transmission apparatus receives signaling containing information on a code rate and a modulation scheme; or
random access preamble sequences are pre-divided into multiple groups, indices of different groups of random access preamble sequences corresponding to different code rates and modulation schemes.

19. A communications system, comprising:
a user equipment configured to perform phase rotation on a random access preamble sequence according to data to be transmitted, so as to carry the data to be transmitted in the random access preamble sequence, and transmit the random access preamble sequence carrying the data to be transmitted via a physical random access channel; and
a base station configured to receive the random access preamble sequence carrying the data to be transmitted, and detect the random access preamble sequence to acquire the data to be transmitted.

20. The communications system according to claim 19, wherein the user equipment is configured to rotate a phase point of the random access preamble sequence by a predetermined angle for each bit of the data to be transmitted according to a value of the bit.
